(19) United States
(12) Patent Application Publication
(10) Pub. No.: US 2014/0098171 A1
(43) Pub. Date: Apr. 10, 2014

(54) EXPOSURE DEVICE AND IMAGE FORMING APPARATUS

(71) Applicant: FUJI XEROX CO., LTD., Tokyo (JP)

(72) Inventor: Junichi TANIGAWA, Mie (JP)

(73) Assignee: FUJI XEROX CO., LTD., Tokyo (JP)

(21) Appl. No.: 13/868,327

(22) Filed: Apr. 23, 2013

(30) Foreign Application Priority Data
Oct. 10, 2012 (JP) 2012-225439

(51) Int. Cl. B41J 2/385

(52) U.S. Cl. CPC G03G 15/04036
USPC 347/118

(57) ABSTRACT

An exposure device includes a substrate, an optical member, and a housing. The substrate extends in one direction, and is mounted with light emitting elements. The optical member extends in the one direction, and images light from the light emitting elements on a target object. The housing includes a body portion and a pair of holding portions. The body portion extends in the one direction, and is attached with the substrate. The holding portions are formed integrally with the body portion, hold therebetween the optical member in a perpendicular direction perpendicular to the one direction, and are formed with separating regions that separate in the perpendicular direction from opposite end portions in the one direction of the optical member.

### CROSS-REFERENCE TO RELATED APPLICATIONS

This application is based on and claims priority under 35 USC 119 from Japanese Patent Application No. 2012-225439 filed Oct. 10, 2012.

### BACKGROUND

### Technical Field

The present invention relates to an exposure device and an image forming apparatus.

### SUMMARY

According to an aspect of the invention, there is provided an exposure device including a substrate, an optical member, and a housing. The substrate extends in one direction, and is mounted with light emitting elements. The optical member extends in the one direction, and images light from the light emitting elements on a target object. The housing includes a body portion and a pair of holding portions. The body portion extends in the one direction, and is attached with the substrate. The holding portions are formed integrally with the body portion, hold therebetween the optical member in a perpendicular direction perpendicular to the one direction, and are formed with separating regions that separate in the perpendicular direction from opposite end portions in the one direction of the optical member.

### BRIEF DESCRIPTION OF THE DRAWINGS

An exemplary embodiment of the present invention will be described in detail based on the following figures, wherein:

FIGS. 1A and 1B are enlarged plan views illustrating a print head and a housing of the print head according to the present exemplary embodiment;

FIGS. 2A and 2B are cross-sectional views illustrating the print head and the housing of the print head according to the present exemplary embodiment, as taken in a direction perpendicular to a drum axial direction;

FIGS. 3A and 3B are cross-sectional views illustrating the print head and the housing of the print head according to the present exemplary embodiment, as taken in the direction perpendicular to the drum axial direction;

FIGS. 4A and 4B are cross-sectional views illustrating the print head and the housing of the print head according to the present exemplary embodiment, as taken in the direction perpendicular to the drum axial direction;

FIGS. 5A and 5B are cross-sectional views illustrating the print head and the housing of the print head according to the present exemplary embodiment, as taken in the drum axial direction;

FIG. 6 is a plan view illustrating the entire print head according to the present exemplary embodiment;

FIG. 7 is an exploded perspective view illustrating the print head according to the present exemplary embodiment; and

FIG. 8 is a schematic configuration diagram illustrating an image forming apparatus according to the present exemplary embodiment.

### DETAILED DESCRIPTION

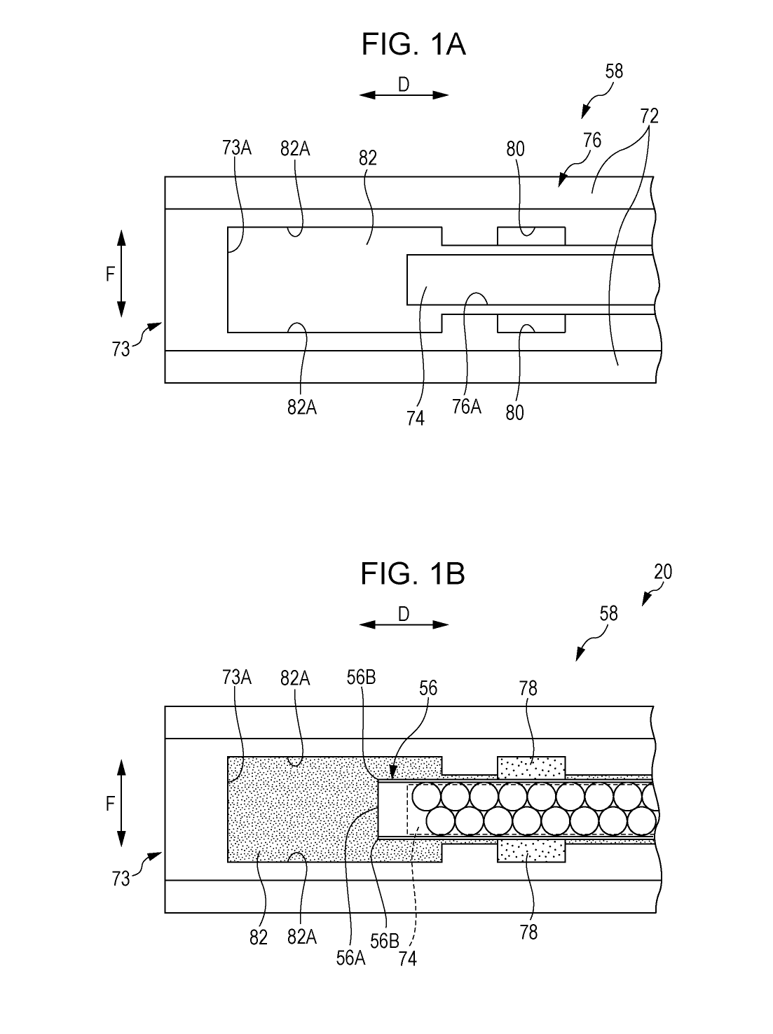

With reference to FIG. 1A to FIG. 8, description will be given of an example of an exposure device and an image forming apparatus according to an exemplary embodiment of the present invention. An arrow UP illustrated in the drawings indicates the vertically upward direction.

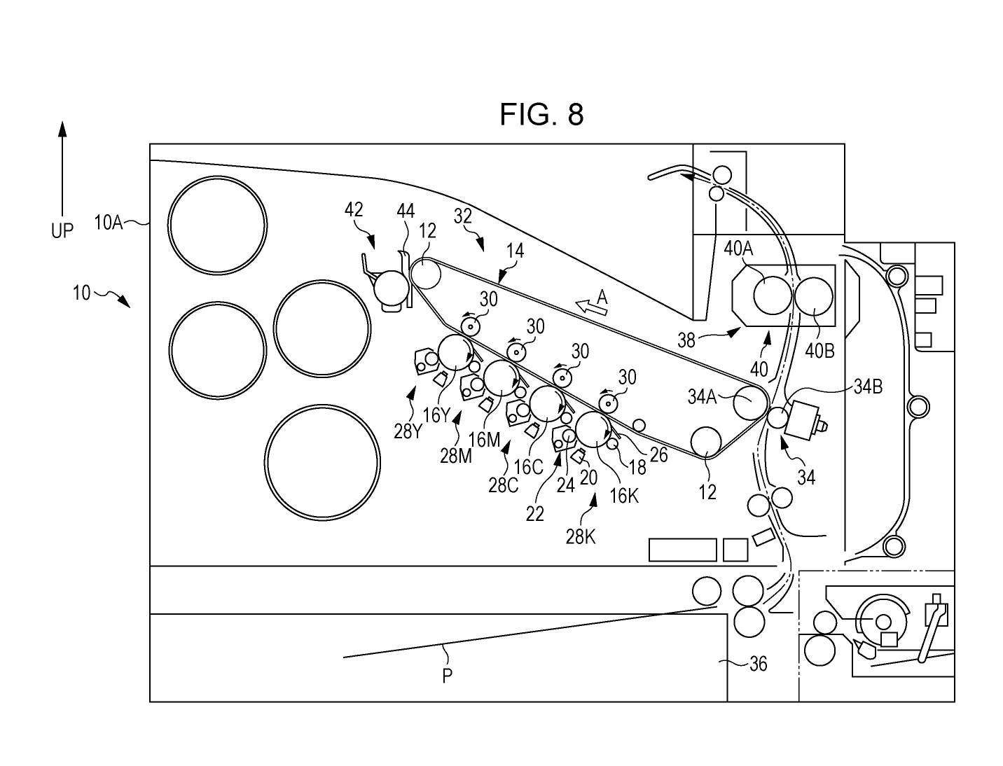

Overall Configuration: As illustrated in FIG. 8, in an apparatus body 10A of an image forming apparatus 10, an intermediate transfer belt 14 having an endless belt shape is provided which configures a transfer unit 32, and which is stretched around plural rollers 12 and driven by a motor (illustration thereof is omitted) to be transported in the direction of an arrow A. In the image forming apparatus 10, which is capable of forming a color image, image forming units 28Y, 28M, 28C, and 28K that form toner images corresponding to four colors of yellow (Y), magenta (M), cyan (C), and black (K) are disposed along the longitudinal direction of the intermediate transfer belt 14, and are supported to be attachable to and detachable from the apparatus body 10A.

Each of members provided for the respective colors is denoted by a reference numeral followed by an alphabetic character indicating the corresponding color (Y, M, C, or K). In description without particular distinction of colors, however, the description will be given with the final alphabetical character omitted.

Image Forming Unit: Each of the image forming units 28 includes a photoconductor drum 16 as an example of an image carrier rotated in the clockwise direction by a not-illustrated drive device including a motor and a gear. Further, on a circumferential surface of the photoconductor drum 16, a charging roller 18 is disposed which uniformly charges the surface of the photoconductor drum 16 to a predetermined potential. Specifically, the charging roller 18 is a conductive roller having a circumferential surface in contact with the circumferential surface of the photoconductor drum 16, and is disposed such that the axial direction of the charging roller 18 and the axial direction of the photoconductor drum 16 are parallel to each other.

Further, on the circumferential surface of the photoconductor drum 16 and downstream of the charging roller 18 in the rotation direction of the photoconductor drum 16, a light emitting diode (LED) print head 20 (hereinafter simply referred to as “the print head 20”) as an example of an exposure device which radiates light onto the photoconductor drum 16 to form an electrostatic latent image extends in the axial direction of the photoconductor drum 16. The print head 20 radiates a light beam to the photoconductor drum 16 in accordance with image data, to thereby form an electrostatic latent image on the photoconductor drum 16. The print head 20 will be described in detail later.

Further, on the circumferential surface of the photoconductor drum 16 and downstream of the print head 20 in the rotation direction of the photoconductor drum 16, a developing unit 22 is disposed as an example of a developing device which develops the electrostatic latent image formed on the photoconductor drum 16 with toner of a predetermined color (yellow, magenta, cyan, or black) to thereby form a toner image.

The developing unit 22 includes a cylindrical developing roller 24 rotatably provided and disposed in the vicinity of the photoconductor drum 16. The developing roller 24 is applied with a developing bias, and the toner loaded in the developing unit 22 adheres to the developing roller 24. Further, with the rotation of the developing roller 24, the toner adhering to the developing roller 24 is transported to the surface of the photoconductor drum 16, and the electrostatic latent image formed on the photoconductor drum 16 is developed into a toner image.

Further, on the circumferential surface of the photoconductor drum 16 and downstream of a later-described transfer roller 30 in the rotation direction of the photoconductor drum 16, a cleaning blade 26 is disposed which collects residual toner on the photoconductor drum 16. The cleaning blade 26, which is disposed with one side thereof being in contact with the photoconductor drum 16, scrapes and collects, for example, toner remaining on the photoconductor drum 16 without being transferred to the intermediate transfer belt 14 by the transfer roller 30 and toner of another color adhering to the photoconductor drum 16 in a transfer process.

Transfer Unit: On the circumferential surface of the photoconductor drum 16 and downstream of the developing unit 22 in the rotation direction of the photoconductor drum 16, the transfer roller 30 configuring the transfer unit 32 is disposed on the opposite side of the photoconductor drum 16 across the intermediate transfer belt 14.

The transfer roller 30 is charged to a predetermined potential and rotates in the counterclockwise direction, to thereby transport the intermediate transfer belt 14 at a predetermined speed and press the intermediate transfer belt 14 against the photoconductor drum 16. Thereby, the transfer roller 30 transfers the toner image on the photoconductor drum 16 onto the intermediate transfer belt 14.

Herein, the toner images of the mutually different colors formed by the respective image forming units 28 are transferred onto a belt surface of the intermediate transfer belt 14 to be superimposed on one another. Thereby, a color toner image is formed on the intermediate transfer belt 14. In the present exemplary embodiment, the toner image formed by the thus superimposed and transferred toner images of the four colors will be referred to as “the final toner image.”

On the downstream side of the photoconductor drums 16 for the respective colors in the transporting direction of the intermediate transfer belt 14, a transfer device 34 configured to include two facing rollers 34A and 34B is disposed. The final toner image formed on the intermediate transfer belt 14 is transferred to a sheet member P picked up from a sheet tray 36 provided in a bottom portion of the image forming apparatus 10 and transported to between the rollers 34A and 34B.

On the downstream side of the transfer device 34 in the transporting direction of the intermediate transfer belt 14, a cleaner 42 is provided which collects toner remaining on the intermediate transfer belt 14 without being transferred to the sheet member P by the transfer device 34. The cleaner 42 includes a blade 44 provided to be in contact with the intermediate transfer belt 14. Accordingly, the remaining toner is scraped and collected.

Fixing Unit: Further, a fixing unit 38 is provided on a transport path of the sheet member P having the final toner image transferred thereto. The fixing unit 38 includes a fixing device 40 configured to include a heating roller 40A and a pressure roller 40B. The sheet member P transported to the fixing device 40 is nipped and transported by the heating roller 40A and the pressure roller 40B. Thereby, the toner on the sheet member P is fused and compressed on the sheet member P to be fixed on the sheet member P.

Operation of Overall Configuration: In the image forming apparatus 10, an image is formed as follows.

The charging roller 18 first uniformly negatively charges the surface of the photoconductor drum 16 to an intended charging portion potential. Further, the print head 20 performs exposure such that an image portion on the charged photoconductor drum 16 has an intended exposure portion potential. Thereby, an electrostatic latent image is formed on the photoconductor drum 16.

Then, when the electrostatic latent image on the rotating photoconductor drum 16 passes the developing roller 24 provided in the developing unit 22, the toner in developer adheres to the electrostatic latent image, and the electrostatic latent image is visualized into a toner image.

The visualized toner images of the respective colors are sequentially transferred to the intermediate transfer belt 14 by electrostatic force of the transfer rollers 30. Thereby, a final color toner image is formed on the intermediate transfer belt 14.

The final toner image is fed to between the rollers 34A and 34B provided in the transfer device 34. The final toner image is then transferred to the sheet member P picked up from the sheet tray 36 and transported to between the rollers 34A and 34B.

Further, the toner image transferred to the sheet member P is fixed thereon by the fixing device 40, and is discharged outside the apparatus body 10A.

Configuration of Major Parts: The print head 20 will now be described.

The print head 20 has an elongated shape, and extends in one direction. Further, in a state in which the print head 20 is attached to the apparatus body 10A, the print head 20 is disposed to extend along the direction of a rotation axis of the photoconductor drum 16 (see FIG. 8) (the direction of an arrow D illustrated in the drawings, hereinafter simply referred to as “the drum axial direction”).

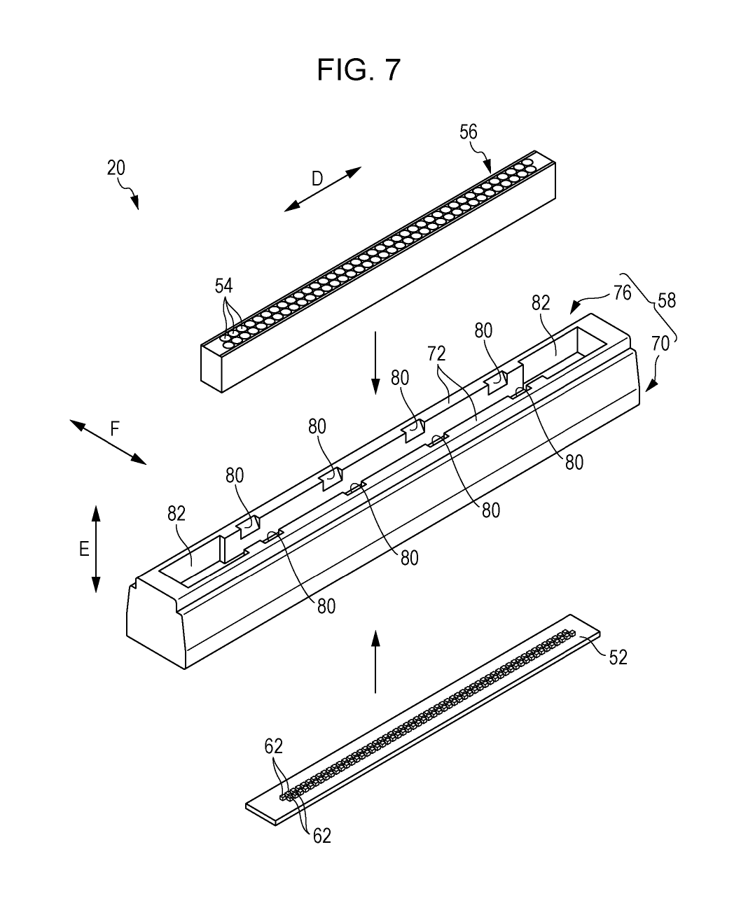

Further, as illustrated in FIG. 7, the print head 20 includes a printed wiring board 52 as an example of a substrate mounted with light emitting diode arrays (LED arrays) 62 as an example of light emitting elements. The print head 20 further includes a lens array 56 and a housing 58. The lens array 56 is an example of an optical member formed with plural cylindrical rod lenses 54 through which light emitted by light emitting points (LEDs) of the light emitting diode arrays 62 passes. The printed wiring board 52 and the lens array 56 are attached to the housing 58.

Directions appearing in the following description correspond to directions in the state in which the print head 20 is attached to the apparatus body 10A.

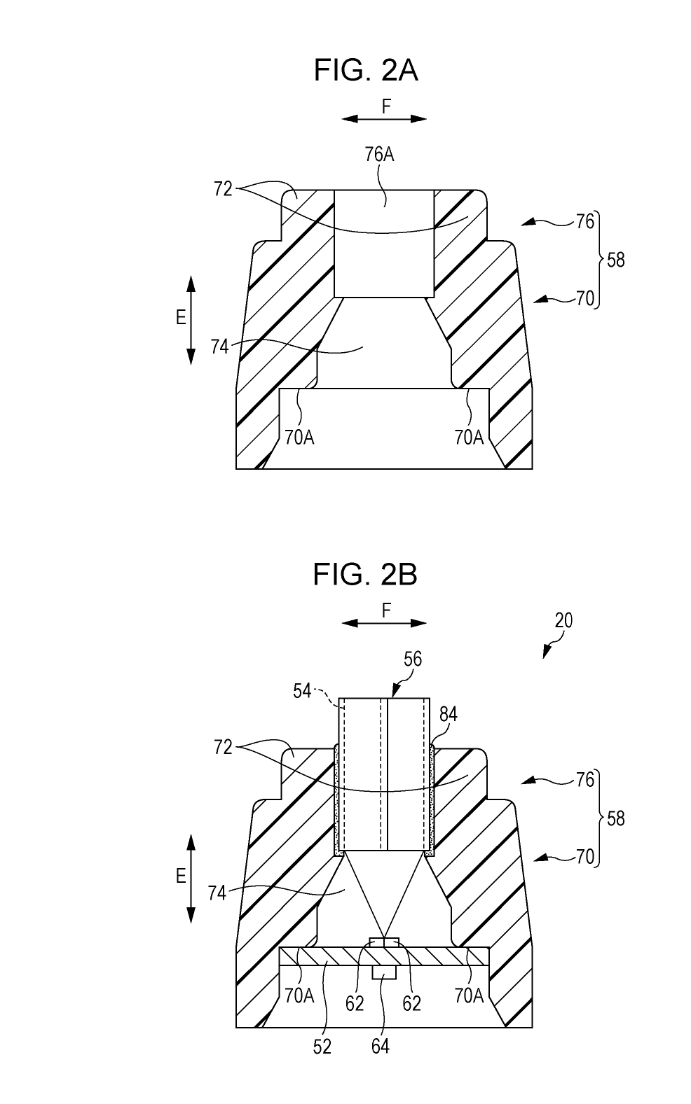

Printed Wiring Board: The printed wiring board 52 extends in the drum axial direction. Further, as illustrated in FIG. 2B and FIG. 7, one surface of the printed wiring board 52 is mounted with the plural light emitting diode arrays 62 arranged in a zigzag fashion and each including plural (128, for example) linearly provided light emitting diodes (LEDs). Meanwhile, the other surface of the printed wiring board 52 is mounted with an electronic component 64 which controls the light emitting diode arrays 62.

Lens Array: The lens array 56 has a rectangular parallelepiped shape extending in the drum axial direction. The lens array 56 has the plural rod lenses 54 through which the light emitted from the light emitting points of the light emitting diode arrays 62 passes, and which are arranged in a zigzag fashion. Accordingly, the light emitted from the light emitting points of the light emitting diode arrays 62 and passing through the rod lenses 54 is imaged on the photoconductor drum 16 (an example of a target object).

Housing: The housing 58 is made of a resin material (liquid crystal polymer, for example), and extends in the drum axial direction. Further, in a state in which the lens array 56 and the printed wiring board 52 are attached to the housing 58, the rod lenses 54 of the lens array 56 and the light emitting diode arrays 62 mounted on the one surface of the printed wiring board 52 face each other, as illustrated in FIG. 2B.

Specifically, as illustrated in FIG. 7, the outer shape of the housing 58 is a substantially rectangular parallelepiped shape extending in the drum axial direction. Further, the housing 58 includes a body portion 70 attached with the printed wiring board 52 and a lens holding portion 76 holding the lens array 56.

Body Portion: As illustrated in FIG. 2A, the body portion 70 is formed with a through-hole 74 through which the light emitted from the light emitting diode arrays 62 toward the rod lenses 54 passes, and which is elongated in the drum axial direction.

Further, a portion of the body portion 70 in which the printed wiring board 52 is attached to the through-hole 74 is open to the outside. In the open portion, a step portion 70A is formed which comes into contact with an outer circumferential plate surface of the printed wiring board 52.

Lens Holding Portion: The lens holding portion 76 is formed with a groove portion 76A which is open in an optical axis direction of the rod lenses 54 (the direction of an arrow E illustrated in the drawings, hereinafter simply referred to as “the lens axial direction”), and in which the lens array 56 is attached.

The groove portion 76A is surrounded by a pair of holding portions 72 and connecting portions 73 (see FIGS. 1A and 1B). The paired holding portions 72 hold therebetween the lens array 56 in a perpendicular direction perpendicular to the drum axial direction and the lens axial direction (the direction of an arrow F illustrated in the drawings, hereinafter simply referred to as “the axis-perpendicular direction”). Each of the connecting portions 73 connects the corresponding end portions in the drum axial direction of the paired holding portions 72.

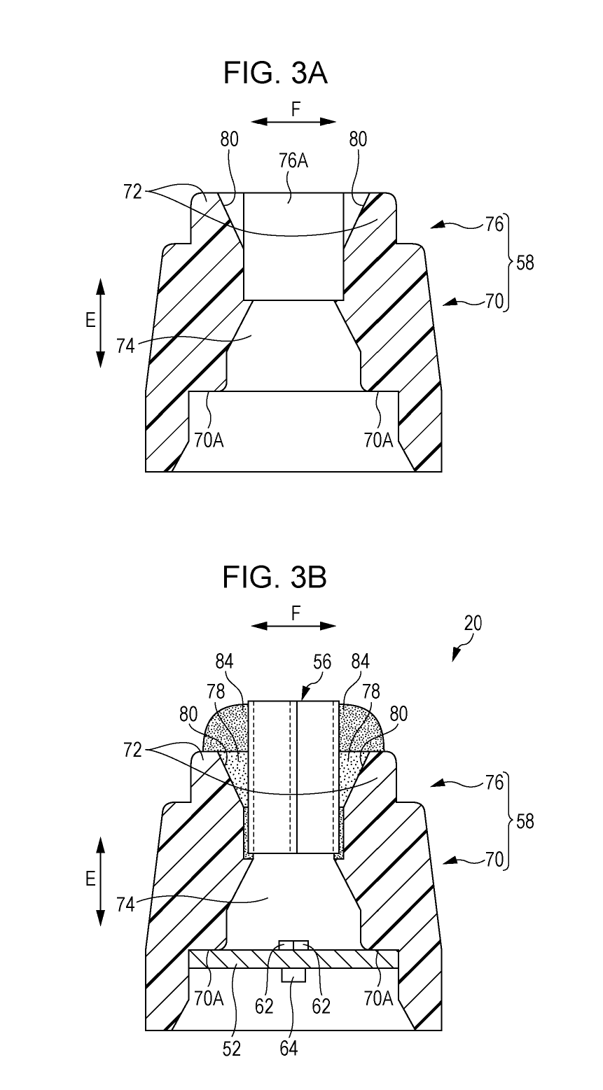

Further, as illustrated in FIGS. 3A and 3B, the paired holding portions 72 are formed with application regions 80 filed with an adhesive 78 with which the lens array 56 held between the paired holding portions 72 is fixed to the holding portions 72.

Each of the application regions 80 has a tapered shape with an open outer portion. As illustrated in FIG. 7, each of the paired holding portions 72 is formed with four application regions 80.

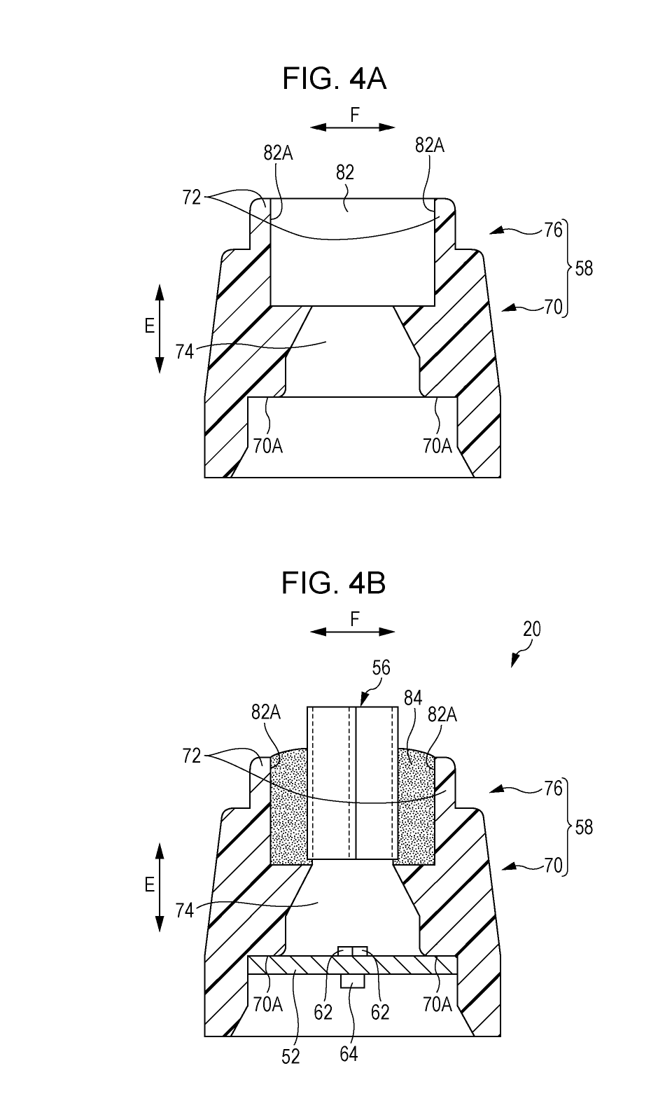

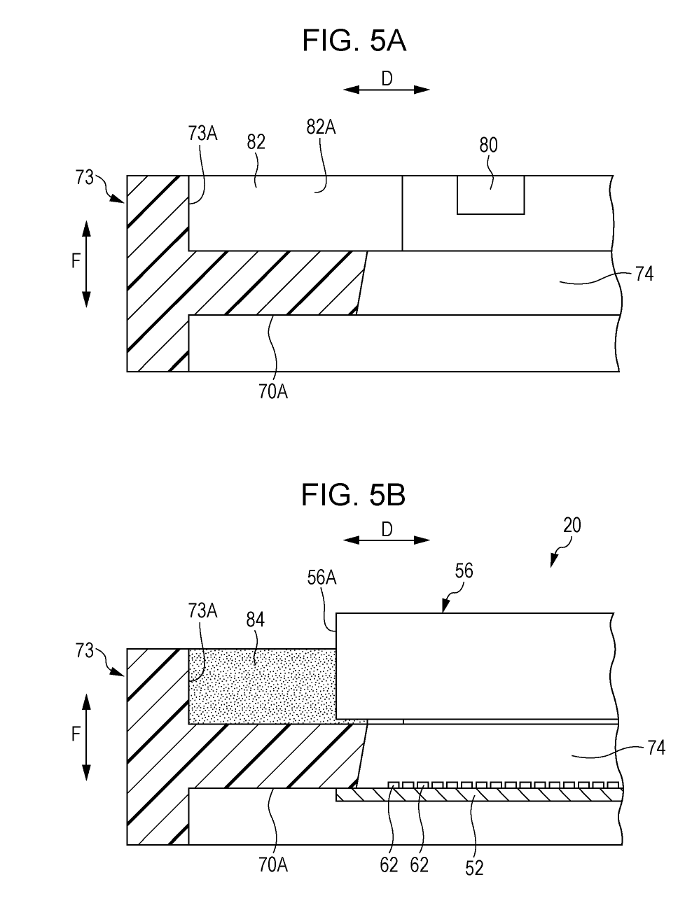

Further, as illustrated in FIGS. 1A and 1B and FIGS. 5A and 5B, a pair of separating regions 82 is formed at the opposite ends in the drum axial direction of the holding portions 72 (FIGS. 1A and 1B and FIGS. 5A and 5B illustrate only one of the separating regions 82). The separating regions 82 separate in the axis-perpendicular direction from opposite end portions in the drum axial direction of the lens array 56 attached to the housing 58. Each of the separating regions 82 has a rectangular shape extending in the drum axial direction, as viewed in the lens axial direction, and a pair of wall surfaces 82A configuring the separating region 82 and the lens array 56 are separated from each other in the axis-perpendicular direction (see FIGS. 4A and 4B).

Further, as illustrated in FIG. 5B, a wall surface 73A configuring the connecting portion 73 and located on the side of the groove portion 76A is separated from an outer end surface 56A in the drum axial direction of the lens array 56. Further, a leading end portion of a nozzle (illustration thereof is omitted) used to apply a sealant 84 for sealing a gap between the housing 58 and the lens array 56 is inserted between the wall surface 73A and the end surface 56A. An application position of the sealant 84 will be described together with a later-described operation.

Further, as illustrated in FIG. 1A, opposite end portions in the drum axial direction of the through-hole 74 are disposed in the separating regions 82, as viewed in the lens axial direction. Further, as illustrated in FIG. 1B, in the state in which the lens array 56 is attached to the housing 58, the through-hole 74 is covered by the lens array 56, as viewed in the lens axial direction.

Operation of Configuration of Major Parts: Description will now be given of an operation (respective processes thereof) of attaching the lens array 56 and the printed wiring board 52 to the housing 58.

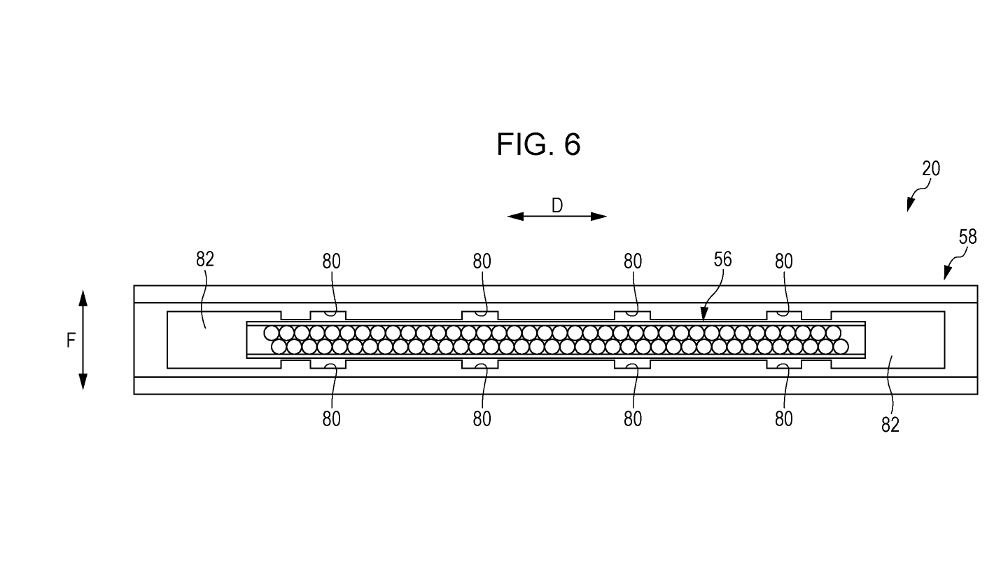

The lens array 56 is first moved toward the housing 58 in the lens axial direction such that the lens array 56 is held between the paired holding portions 72 (see FIG. 6 and FIG. 7). In this state, the adhesive 78 is injected into the application regions 80 and cured. Thereby, the lens array 56 is fixed to the housing 58, as illustrated in FIG. 3B (a lens attaching process).

More specifically describing the lens attaching process, outer portions of the holding portions 72 or the body portion 70 located substantially at the center thereof in the drum axial direction are first sucked by a pair of not-illustrated vacuum pads. Then, the paired vacuum pads are moved in respective directions of separating the holding portion 72 from each other. Thereby, an internal gap between the holding portions 72 is sufficiently increased, as compared with the width of the lens array 56. The lens array 56 is moved in the lens axial direction into the sufficiently increased gap between the paired holding portions 72. Then, the paired vacuum pads are moved in respective directions of causing the holding portions 72 to approach each other to bring the lens array 56 and the holding portions 72 into contact with each other, and thereafter the suction of the vacuum pads is released. Then, the adhesive 78 is applied and cured, as described above.

Then, the leading end portion of the nozzle (illustration thereof is omitted) for applying the sealant 84 is inserted in one of the separating regions 82, and the sealant 84 is ejected from the nozzle. Thereby, a gap between one end portion of the lens array 56 and the housing 58 is sealed. After the ejection of the sealant 84 is stabilized, the leading end portion of the nozzle is moved toward the other separating region 82 along a boundary between the lens array 56 and one of the holding portions 72. Thereby, a gap between a side surface of the lens array 56 and the one of the holding portions 72 applied with the sealant 84 is sealed.

The sealant 84 is further ejected from the nozzle having reached the other separating region 82. Thereby, a gap between the other end portion of the lens array 56 and the housing 58 is sealed. Further, the leading end portion of the nozzle is moved toward the one of the separating regions 82 along a boundary between the lens array 56 and the other holding portion 72. Thereby, a gap between a side surface of the lens array 56 and the other holding portion 72 applied with the sealant 84 is sealed. The gap between the entire circumference of the lens array 56 and the housing 58 is thus sealed by the sealant 84 (a sealing process).

As illustrated in FIG. 3B, the sealant 84 is ejected from the not-illustrated nozzle to spread across the lens array 56 and the housing 58 so as to cover the entire application regions 80. This is due to the following reason. That is, if the amount of the adhesive 78 applied to the application regions 80 is insufficient, the outside and the inside of the housing 58 communicate with each other, and dust and so forth enter the housing 58 from outside thereof. Even in such a case, however, with the sealant 84 applied to cover the entire application regions 80, it is possible to prevent the outside and the inside of the housing 58 from communicating with each other, and thus prevent dust and so forth from entering the housing 58 from outside thereof. The term communicating refers to two spaces (the inside and the outside of the housing 58 in this case) being continuously connected to each other.

Then, the printed wiring board 52 is moved toward the housing 58 in the lens axial direction such that the outer circumferential plate surface of the printed wiring board 52 and the step portion 70A come into contact with each other (see FIG. 2B and FIG. 5B). In this state, with the use of a fixing member (illustration thereof is omitted) for fixing the printed wiring board 52 to the housing 58, the printed wiring board 52 is fixed to the housing 58 (a substrate attaching process).

Herein, if the lens array 56 is inclined relative to the housing 58, as viewed in the lens axial direction, when the lens array 56 is moved in the lens axial direction in the above-described lens attaching process, it is possible that friction occurs between the holding portions 72 and corner portions 56B of the opposite end portions in the drum axial direction of the lens array 56. This is due to the following reason. At respective central portions in the drum axial direction of the holding portions 72, it is possible to sufficiently increase the gap between the paired holding portions 72 by using the above-described vacuum pads. Therefore, there is no friction between lens array 56 and the housing 58, even if the lens array 56 is inclined relative to the housing 58. Meanwhile, such an effect is not obtained at the opposite ends in the drum axial direction of the holding portions 72. In other words, the holding portions 72 are connected to each other at the opposite ends thereof in the drum axial direction, and thus it is difficult to widen the gap between the holding portions 72 at the opposite ends. However, with the separating regions 82 formed at the opposite ends in the drum axial direction of the holding portions 72, the occurrence of friction between the wall surfaces 82A and the corner portions 56B of the lens array 56 (or curvature end portions in the case of rounded (circular arc) corner portions) is suppressed, as illustrated in FIG. 1B.

Further, with the suppression of friction between the corner portions 56B of the lens array 56 and the wall surfaces 82A, the occurrence of dust by friction is suppressed.

Further, with the suppression of occurrence of dust, a situation is suppressed in which occurring dust enters the print head 20 and adheres onto the light emitting points, for example, thereby degrading the optical properties of the print head 20.

Further, with the suppression of degradation of the optical properties of the print head 20, the deterioration of the quality of the image output from the image forming apparatus 10 is suppressed.

Further, as described above, the opposite end portions in the drum axial direction of the through-hole 74 are disposed in the separating regions 82. For example, there is a case in which molding shrinkage or the like occurring in a molding process causes the paired holding portions 72 to approach each other in the axis-perpendicular direction, as compared with the designed shape thereof. The opposite end portions of the through-hole 74, however, extend into the separating regions 82. When the paired holding portions 72 are separated from each other by the use of a jig or the like, therefore, the paired holding portions 72 easily separate from each other, as compared with a case in which the opposite end portions of the through-hole 74 do not extend into the separating regions 82.

Further, with the paired holding portions 72 which easily separate from each other in the axis-perpendicular direction, the lens array 56 is easily attached to the housing 58.

A specific exemplary embodiment of the present invention has been described in detail. However, it will be apparent to practitioners skilled in the art that the present invention is not limited to the exemplary embodiment, and that various other exemplary embodiments are possible within the scope of the present invention. For example, in the above-described exemplary embodiment, the lens array 56 is attached to the housing 58, and thereafter the printed wiring board 52 is attached to the housing 58. However, these processes may be performed in reverse order. Further, the lens array 56 and the printed wiring board 52 may be simultaneously attached to the housing 58.

What is claimed is:

1. An exposure device comprising:
a substrate that extends in one direction, and is mounted with light emitting elements;
an optical member that extends in the one direction, and images light from the light emitting elements on a target object; and
a housing including
a body portion that extends in the one direction, and is attached with the substrate, and
a pair of holding portions that are formed integrally with the body portion, hold therebetween the optical member in a perpendicular direction perpendicular to the one direction, and are formed with separating regions that separate in the perpendicular direction from opposite end portions in the one direction of the optical member.

2. The exposure device according to claim 1, wherein the housing is formed with a through-hole through which the light emitted from the light emitting elements toward the optical member passes, and which is elongated in the one direction, and
wherein opposite end portions in the one direction of the through-hole are disposed in the separating regions, as viewed in an optical axis direction of the optical member.

3. An image forming apparatus comprising:
an image carrier;
the exposure device according to claim 1 that exposes the image carrier with light to thereby form an electrostatic latent image; and
a developing device that develops the electrostatic latent image formed on the image carrier by the exposure device.

4. An image forming apparatus comprising:
an image carrier;
the exposure device according to claim 2 that exposes the image carrier with light to thereby form an electrostatic latent image; and
a developing device that develops the electrostatic latent image formed on the image carrier by the exposure device.
